(19) United States
(12) Patent Application Publication
(10) Pub. No.: US 2002/0088181 A1
(43) Pub. Date: Jul. 11, 2002

(54) Remote control gate

(76) Inventor: David Friesen, Alberta (CA)

Correspondence Address: ADE & COMPANY, 1700-360 MAIN STREET, WINNIPEG, MB, R3C3Z3, CA

(21) Appl. No.: 09/997,216

(22) Filed: Nov. 30, 2001

Related U.S. Application Data
(60) Provisional application No. 60/253,985, filed on Nov. 30, 2000.

(51) Int. Cl. E06B 11/00; E05F 11/02

(52) U.S. Cl. 49/381; 49/331

(57) ABSTRACT

A gate includes a gate panel mounted on a post which provides a horizontal pivot where the pivot axis is at right angles to the gate panel and adjacent or at a bottom corner of the gate panel. The gate is carried on one side of the post so that the gate can be pulled in pivotal movement around the horizontal pivot axis so that the gate raises and folds inwardly beyond the mounting pivot to a retracted position standing up alongside the post. A winch assembly attached to the support beyond the post provides a cable which attaches to the panel at a position spaced outwardly and upwardly from the pivot so as to pull the panel to the raised position. A spring coiled at the pivot biases the panel to a mid point of its movement.

This invention relates to a gate which can be pivoted between open and closed positions by a simple remote controlled winch of the type used for opening garage doors.

### BACKGROUND OF THE INVENTION

Fence line gates such as those in cattle operations and similar locations require to be opened and closed repeatedly to allow passage of authorized vehicles. In most cases it is necessary for the operator of the vehicle to exit the vehicle, open the gate, drive the vehicle through the gate and re-close the gate. Remote control openers which act to pivot the gate about its normal vertical axis are available but complex as they require to drive in both directions that is to open and to close.

It is highly desirable therefore to provide a remote control gate which can be readily opened and closed using simple operating systems. Attempts have been made therefore to pivot the gate about its vertical axis by an operator system which pulls the gate open and closed so that the driver of the vehicle can simply actuate the remote control system to open and close the gate without the necessity for exiting from the vehicle. However these devices have been complex and ineffective.

It is one object of the present invention to provide an improved gate construction which allows the gate to be opened and closed using a simple winch drive arrangement.

### SUMMARY OF THE INVENTION

According to one aspect of the invention there is provided a gate comprising a rectangular gate panel and a mounting arrangement for the panel which provides a horizontal pivot where the pivot axis is at right angles to the gate panel and adjacent or at a bottom corner of the gate panel. The mounting supports the gate alongside a support for the pivot so that the gate can be pulled in pivotal movement around the horizontal pivot axis so that the gate raises and folds inwardly beyond the mounting pivot to a retracted position standing up alongside the support.

The gate is pulled by a simple cable which attaches to the top edge of the panel at a position spaced outwardly from the pivot.

The position at the connection of the cable to the top rail of the gate is arranged so that that point moves to a position closely adjacent the winch.

The gate, mounted on a post which forms an end post of a fence line so that the gate pivots to a position lying alongside the fence line in its retracted position.

The gate is arranged so that it is biased toward the deployed position either by a spring or by the location of the centre of gravity so that it returns to the deployed position as the cable is released from the winch.

One embodiment of the invention will now be described in conjunction with the accompanying drawings in which:

### BRIEF DESCRIPTION OF THE DRAWINGS

FIG. 1 is a front elevational view of the gate according to the present invention.

FIG. 2 is a top plan view of the gate of FIG. 1.

FIG. 3 is a front elevational view of a second embodiment of a gate according to the present invention showing the gate in the lowered or closed position.

FIG. 4 is a front elevational view of the gate of FIG. 3 in the open or raised position.

FIG. 5 is a front elevational view on an enlarged scale of the pulley for raising the gate with the front cover of the pulley removed.

FIG. 6 is a vertical cross sectional view through the pulley of FIG. 5.

FIG. 7 is a front elevational view on an enlarged scale showing the biasing spring of the gate of FIG. 3.

FIG. 8 is a side elevational view of the gate of FIG. 3 in the open or raised position.

In the drawings like characters of reference indicate corresponding parts in the different figures.

### DETAILED DESCRIPTION

A fence line includes an end post 10 and a second post 11 adjacent to but spaced from the end post. The post 10 and 11 are connected by transverse rails 12 which may include diagonal rails so as to hold the posts vertical despite tension from a fence 13 which can be of barbed wire or other fencing elements including electric fencing.

The gate comprises a rectangular gate panel 15 with an outer vertical 16 an inner vertical 17 and a plurality of horizontal rails 18. The rails include a top rail 19 and a bottom rail 20.

The gate is shown in the deployed position in which the outer vertical 16 is adjacent to a side post 21 to which the fencing 22 is attached. Thus the gate spans the area between the posts 10 and 21 closing the fence line to the passage of animals.

The rectangular panel forming the gate is mounted on a support bracket 22 carried on a pivot 23 attached adjacent to the bottom of the post 10.

The pivot 23 comprises a first sleeve 23A attached to the post and a second sleeve 23B attached to the bracket 22. The sleeves are arranged for common pivotal movement about a horizontal axis 24 at right angles to the panel of the gate and adjacent the bottom of the post 10. The sleeves 23A and 23B are mounted upon a pin which holds the gate in the vertical plane of the fence line and holds the gate at a position slightly offset to one side of the fence line so that in a retracted position it lies in a plane 25 on one side of the plane of the fence line.

The bracket 22 includes two arms 22A and 22B projecting outwardly from the pivot sleeve 23B to the end vertical 17 and the bottom rail 20 respectively. Thus the pivot axis 24 is arranged adjacent the bottom corner of the gate panel.

A winch assembly 30 of the type generally used in operating remote garage doors and thus of a type which is readily commercially available for a relatively cheap price includes a container 31 which is attached to the post 11 so as to be held in fixed position thereon. The winch includes an antenna 32 by which the system can be operated by way of a control 34 responsive to a signal from a remote transmitter so as to drive a winch drum 35 to pull in and pay out a cable 36. The cable 36 extends from the winch drum 35 to a lug 40 on the top rail of the gate. Operation of the winch therefore acts to pull in the cable 36 thus raising the gate in rotational movement about the pivot axis 24 so that both the bottom rail 20 and the end vertical 17 pivot in a clockwise direction to take up a position alongside the fence line at the rails 12. The location of the lug 40 is arranged so that it moves to a position adjacent the front of the actuator 30.

The gate can therefore can be simply raised by the driver of a vehicle by operating the remote control and when the vehicle is passed the gate can be lowered by reversing the winch 35 to lower the gate back to its initial position. The device is simple with a simple pulling action provided by the winch 35. The gate can be spring biased back to its deployed position by a spring at the pivot 23. Alternatively it can be raised only to a position where its centre of gravity does not pass over the pivot 23 so that it moves back to the deployed position by its own weight.

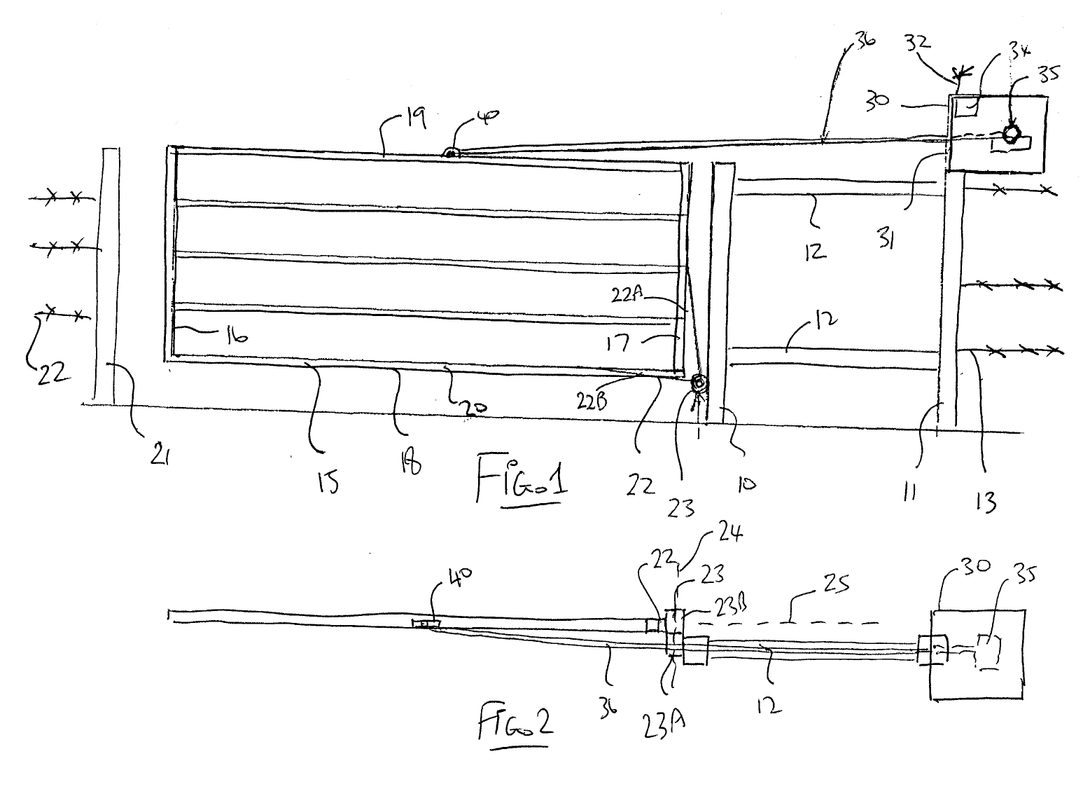

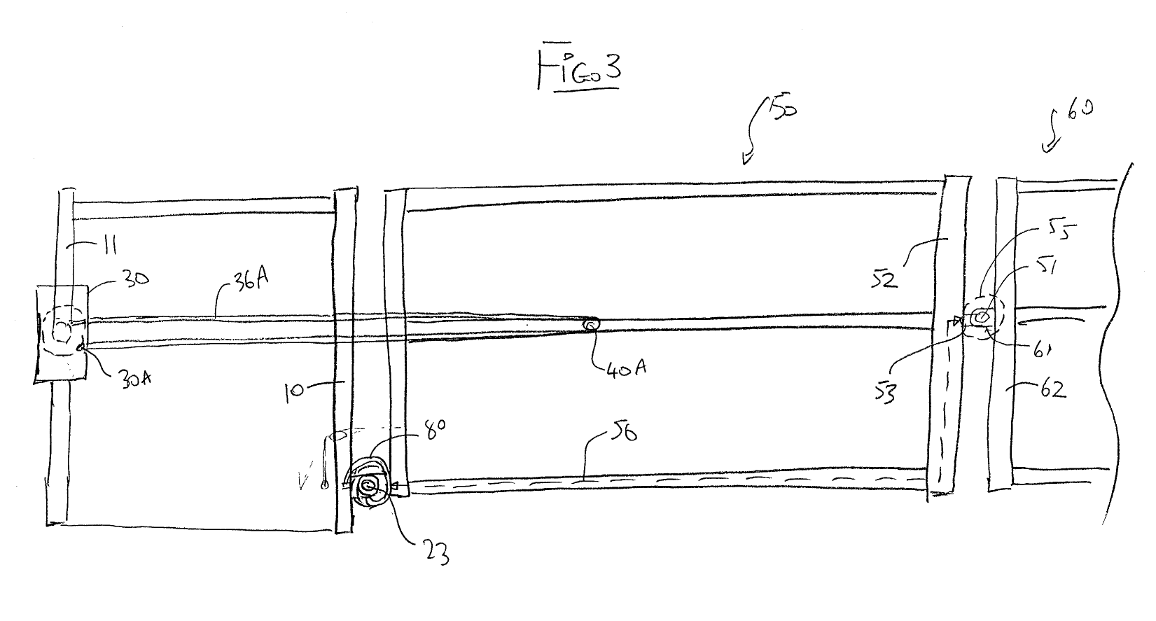

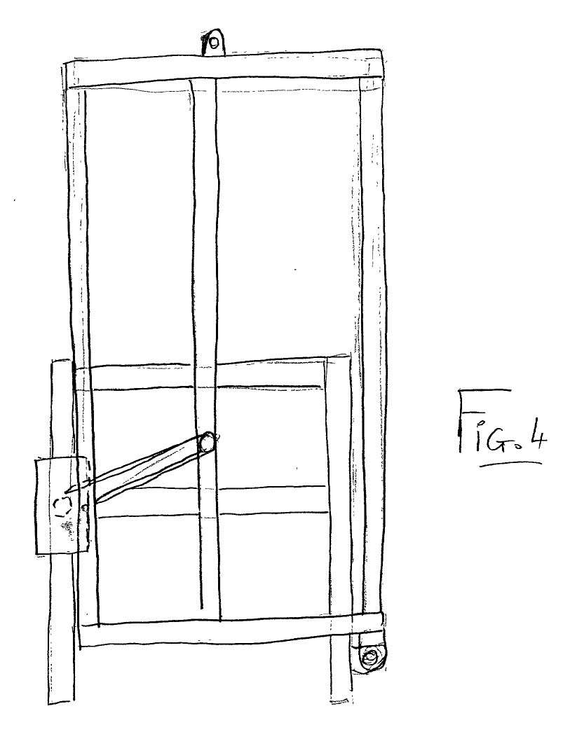

Turning now to the embodiment shown in FIGS. 3 through 8, this is modified relative to the arrangement of FIGS. 1 and 2 by a number of optional modifications. Thus firstly the gate is formed in two sections indicated generally at 50 and 60. Thus the gate section 50 operates as previously described and is basically as previously described. The gate section 60 is connected to the section 50 at a pivot pin 51 at the outer end post 52 of the section 50. The pivot pin is mounted halfway up the post 52 on a support bracket 53 and the pivot pin is connected to the section 60 by a bracket 61 on the end post 62 of the section 60. Thus the section 60 is cantilevered outwardly from the post 52 on the pivot pin 51 and is maintained in the closed horizontal position shown in FIG. 3 by a support 55 which holds the bracket 61 at a predetermined angular orientation around the pivot pin 51. The support can be provided by a chain and sprocket arrangement connected to the pivot 51 so that rotation of the sprocket drives the section 60 around the pivot pin 51 to change its angular orientation relative to the section 50. Thus in the horizontal closed position shown in FIG. 3 the section 60 is supported at the end of the section 50 and is maintained in the horizontal position extending outwardly from the end of the section 50.

As the section 50 is raised as previously described from the horizontal closed position to the vertical open position by rotation of the section 50 about the pivot pin 23, the movement of the section 50 around the pivot pin 23 acts to drive movement of the section 60 around the pivot pin 51. Thus the movement is controlled by a sprocket and chain arrangement extending from the mounting 55 as schematically indicated at 56 to a sprocket at the pivot pin 23. The chain and sprockets are arranged so that the 90° movement of the section 50 around the pivot 23 causes 180° of movement at the section 60 around the pin 51. Thus as seen by comparing the positions shown in FIGS. 3 and 8, as the section 50 is raised through 90° through the vertical position shown in FIG. 8, the section 60 is rotated through 180° so that it hangs down from a top of the section 50 so as to lie in front of the section 50 and away from the post 10.

The two section gate is an optional arrangement for use where the gate is particularly long for example greater than 12 feet in length so that it is mechanically desirable to reduce the length of the gate as it pivots upwardly both from the point of view mechanical advantage and the point of view of the total raised height of the gate in the vertical open position.

The arrangement shown in FIG. 3 can operate effectively and the other modification shown in FIG. 3 can be used without the double section gate 50, 60.

Other arrangements for controlling the location of the second section 60 around the pivot pin 51 can be provided other than the sprocket and chain arrangement described above, bearing in mind that the movement of the first section 50 relative to the fixed post 10 is used by a mechanical linkage to cause the necessary movement of the second section 60 relative to the first section 50.

In accordance with the second modification, the pulley 30 is mounted at a position on the post 11 so that it is no longer at the top of the gate but is instead approximately at a mid height of the gate. It will be appreciated therefore that the connection point on the gate section 50 from the cable 36A does not need to extend to the top of the gate but instead can be located at any point on the height of the gate provided that sufficient mechanical advantage around the pivot pin 23 is provided. In order to increase the mechanical advantage in the arrangement shown, therefore, the connection point to the gate section 50 is provided as a pulley 40A so that the cable 36A extends from the pulley on the winch assembly 30 around the pulley 40A and back to the winch assembly at a fixed connection point 30A so as to double the mechanical advantage of the cable 36A to accommodate the approximate halving of the mechanical advantage by the lowering of the height of the cable and thus the reduction in distance of the cable from the pivot pin 23. A yet further increase in the mechanical advantage could be provided by providing a further pulley at the point 30A so that the cable extends again back to a fixed connection point on the gate section.

The location of the winch assembly 30 at a reduced height allows it to be positioned so as to be more aesthetically pleasing rather than as a raised utilitarian object standing on top of the post 11. While the aesthetic appearance of the winch assembly is not of importance in a cattle fence line for example, it may be more desirable where the gate assembly is used as an entrance gate for a driveway so that the appearance of the gate and its mounting may be more important thus requiring the operating components to be hidden or at least camouflaged.

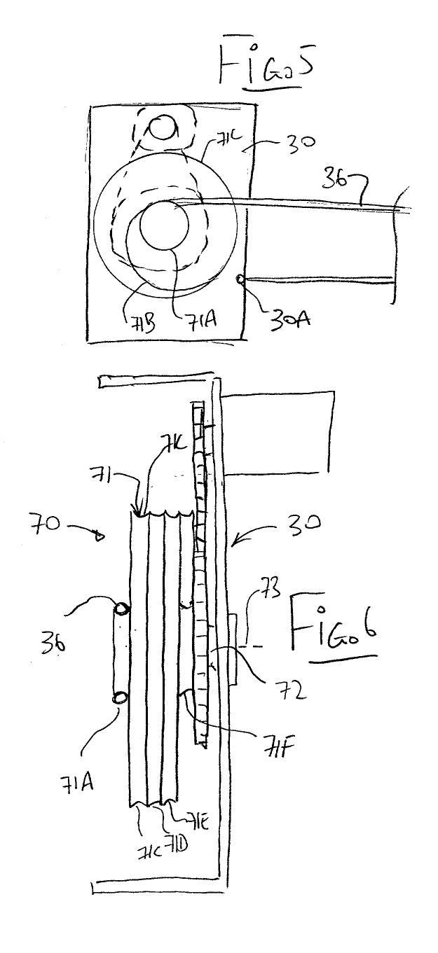

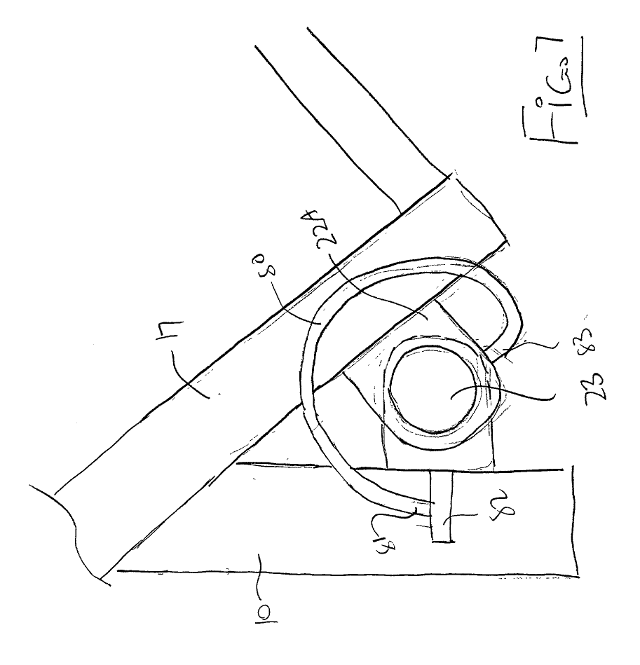

In accordance with a third modification, as shown in FIGS. 5 and 6, the pulley 70 of the winch assembly includes a track 71 for the cable 36 which has a diameter which changes along the length of the track. Thus the pulley is mounted on a mounting shaft and bearing 72 for rotation around a horizontal axis 73 and defines the track 71 which extends axially along the axis 73 to provide a series of side by side track portions. The first track portion 71A is of a small diameter around the axis 73 and then increases helically as indicated at 71B to a second section 71C which is of larger diameter. Thus the amount of movement of cable 36 caused by rotation of the pulley in the first section 71A is relatively small since the diameter of that section is relatively small and then the amount of movement increases through a plurality of side by side helical sections 71C, 71D and 71E to provide the necessary high speed movement of the cable through a center part of its movement. Finally the track 71 again drops down to a small diameter as indicated at 71F at the end of the extended movement. The full length of the track is equal to the full required amount of movement of the cable 36 so that the slow movement is arranged at the beginning of movement and at the end of the movement both in the retraction and the paying out of the cable. Thus the gate panel is moved relatively slowly at both ends of its movement and relatively quickly during the main part of its movement so that there is no rapid acceleration and deceleration at the ends and the mechanical advantage is increased at the ends.

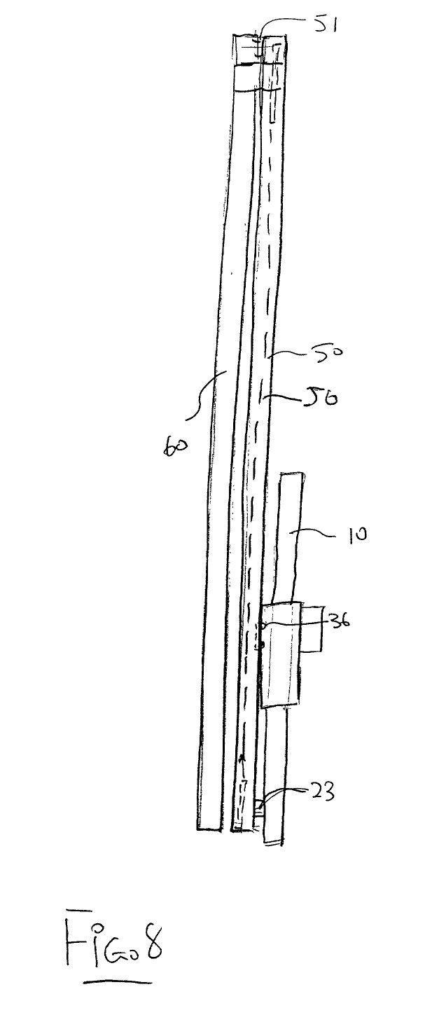

In accordance with a further modification, there is provided a spring 80 shown in FIG. 3 and shown on a larger scale in FIG. 7. The spring 80 is a coil spring having one end 81 connected to the post 10 on a bracket 82. The other end 83 of the coil spring is connected to the bracket 22 connected to the post 17 of the gate panel. The rest position of the spring is arranged at the 45° angle of the gate post 17 as shown in FIG. 7 so that the spring is tensioned as the gate panel rotates around the pin 23 from the rest position either toward the raised position or the lowered position so that the spring resists movement away from the rest position and also assists movement of the gate away from either extreme position toward the center 45° position. Thus the spring assists the cable in raising the gate from the horizontal closed position and also the spring acts to push the gate back from the vertical open position toward the horizontal closed position.

Alternative arrangements of spring can be provided which provide this characteristic. In addition, a supplementary spring can be provided which provides additional lifting force around the 45° position and particularly between the 22° position and the 67° position where the required force on the cable is at a maximum so that the total force on the cable can be maintained substantially constant by the provision of such an assisting spring.

The gate arrangement of the present invention therefore provides a construction which has a simple single pivot point at the bottom corner of the gate panel and allows the gate panel to be pivoted around that bottom corner inwardly into a raised position where the gate stands upwardly alongside the open area between the gate posts leaving that area wholly open for the passage of vehicles. The gate allows the use of a simple pulling cable to raise the gate so that the opening is effected by a cable rather than the necessity for a pushing action by more complex mechanical levers. The movement of the gate can be provided simply by gravity or by the provision of additional biasing springs.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A gate comprising:
a gate panel;
a mounting support for the panel which provides a horizontal pivot where the pivot axis is at right angles to the gate panel and adjacent or at a bottom corner of the gate panel;
the mounting support being arranged to support the gate on one side thereof so that the gate can be pulled in pivotal movement around the horizontal pivot axis so that the gate raises and folds inwardly beyond the mounting pivot to a retracted position standing up alongside the support;
and a winch assembly attached to the support and providing a cable which attaches to the panel at a position spaced outwardly and upwardly from the pivot.

2. The gate according to claim 1 wherein the point of the connection of the cable to the gate is arranged so that that the point moves to a position closely adjacent the winch.

3. The gate according to claim 1 wherein the gate is mounted on a post which forms an end post of a fence line so that the gate pivots to a position lying alongside the fence line in its retracted position.

4. The gate according to claim 1 wherein the gate is arranged so that it is biased toward the deployed position either by a spring or by the location of the centre of gravity so that it returns to the deployed position as the cable is released from the winch.

5. The gate according to claim 4 wherein the spring is arranged at the pivot.

6. The gate according to claim 5 wherein the spring is coiled around the pivot.

7. The gate according to claim 5 wherein the spring is biased toward a mid point of its movement so as to be stressed toward both extreme positions.

8. The gate according to claim 1 wherein the winch assembly includes a pulley which provides a cable rack which has a smaller diameter at its ends than at a center portion so as to provide a reduced cable movement at the ends.

9. The gate according to claim 1 wherein the point of connection of the cable to the panel is below the top.

10. The gate according to claim 1 wherein there is provided a second panel pivotally connected to the first about a pivot at the end of the first, where the second is cantilevered from the first in the closed position and is suspended from the first in the open position.
